(19) United States
(12) Patent Application Publication
(10) Pub. No.: US 2007/0124056 A1
(43) Pub. Date: May 31, 2007

(54) Method for efficient use of roadways with advantages for reducing traffic congestion

(76) Inventor: Carl W. Schulthess, Mission Viejo, CA (US)

Correspondence Address: PATENT LAW & VENTURE GROUP, 2424 S.E. BRISTOL, SUITE 300, NEWPORT BEACH, CA, 92660, US

(21) Appl. No.: 11/586,979

(22) Filed: Oct. 25, 2006

Related U.S. Application Data
(60) Provisional application No. 60/729,978, filed on Oct. 25, 2005.

(51) Int. Cl. G08G 1/00

(52) U.S. Cl. 701/117

(57) ABSTRACT

A method for efficient commuting employs a commuting system having a network of roadways, a plurality of garaging hubs in traffic communication with the network of roadways, a plurality of mass transit vehicles, and a plurality of personal vehicles. Commuters are granted use of the commuting system as registered users. Each of the users is given access to one of the personal vehicles at a first selected one of the garaging hubs for use in moving between this hub and the user's home. Each of the users is likewise given access to another one of the personal vehicles at a selected second one of the garaging hubs for use in moving between this hub and the user's workplace. Between these two hubs, the user is given access to the mass transit vehicles.

### CROSS-REFERENCE TO RELATED APPLICATIONS

This application reflects the subject matter of a prior filed Provisional Patent Application filed on Oct. 25, 2005 and having serial number 60/729978 and claims the filing date thereof as a priority.

### STATEMENT REGARDING FEDERALLY SPONSORED RESEARCH OR DEVELOPMENT

Not applicable.

### THE NAMES OF THE PARTIES TO A JOINT RESEARCH AGREEMENT

Not applicable.

### INCORPORATION-BY-REFERENCE OF MATERIAL SUBMITTTED ON A COMPACT DISC

Not applicable.

### REFERENCE TO A “MICROFICHE APPENDIX”

Not applicable.

### BACKGROUND OF THE INVENTION

### FIELD OF THE PRESENT DISCLOSURE

The present invention relates to methods of efficient traffic control and specifically to a method for leasing vehicles for local use coupled with providing mass transit solutions for long distance use to a set of commuters.

### Description of Related Art Including Information Disclosed Under 37 CFR 1.97 and 1.98

Susan Shaheen et al, “Carlink- A Smart Carsharing System Field Test Report,” dated May 1, 2000, presents the results from the CarLink field test, a smart carsharing system which combines short-term rental vehicles with communication and reservation technologies to facilitate shared-vehicle access. The CarLink field test results include: operational understanding; participant profiles; behavioral findings; economic viability; and directions for future research.

Susan Shaheen et al, “U.S. Shared-use Vehicle Survey Findings: Opportunities and Obstacles for Carsharing and Station Car Growth,” dated Jun. 1, 2003, presents an overview of market growth for shared-use vehicle programs since 1998, looking at topics such as organizational size, partnerships, pricing, costs, and technology. The authors discuss the emergence of more growth-oriented organizations, total membership, and vehicle trends. In the second section, the authors examine several challenges facing organizations and explore opportunities for overcoming them. The report concludes with a summary of key observations and conclusions.

Susan Shaheen et al, “Carlink II: A Commuter Carsharing Pilot Program Final Report,” dated Aug. 1, 2004, shared-use vehicle services provide members access to a fleet of vehicles for use throughout the day, without the hassles and costs of individual auto ownership. From June 2001 to July 2002, the authors surveyed 17 U.S. shared-use vehicle service organizations on a range of topics, including organizational size, strategic partnerships, pricing strategies, insurance costs, and technology applications. While survey findings demonstrate a decline in the number of organizational starts in the last year, the rate of operational launches into new cities, membership, and fleet size continue to increase. Several growth-oriented organizations in the U.S. are responsible for the majority of this expansion.

Susan Shaheen, et al, “U.S. Shared-use Vehicle Survey Findings: Opportunities and Obstacles for Carsharing and Station Car Growth,” dated Jun. 1, 2003, explores several factors that challenge shared-use vehicle growth, such as high capital investment (or start-up costs), dramatic hikes in insurance rates, and scarcity of cost-effective technologies. The authors conclude that while early niche market findings are encouraging, the ability of this emerging sector to actualize its total environmental, economic, and social goals may be limited without the collective support of private industry (e.g., automakers, insurance providers, technology producers), public agents (e.g., transit and governmental agencies), and shared-use vehicle programs. Indeed, public-private partnerships and cooperation among shared-use vehicle providers may play a key role in addressing insurance and technology costs and assuring the long-term viability of this market.

Susan Shaheen, “Dynamics in Behavioral Adaptation to a Transportation Innovation: A Case Study of Carlink-A Smart Carsharing System” dated Jan. 12, 1999, presents research focusing on the results of a longitudinal survey and focus groups which explored responses to a smart carsharing concept. The carsharing model developed and explored in the research is known as CarLink. In the project, a fleet of vehicles is shared by three categories of participants. The rapid transit system BART serves as the principal access hub in the project. The survey results provide the attitudinal and belief data needed to evaluate dynamics in an individual's learning and valuing response to an innovation.

The related art described above explores ways of combining various modes of transportation with controlled scheduling. However, the prior art fails to disclose a commuting scheme for radical reduction in cost and gains in benefits of the present method. The present disclosure distinguishes over the prior art providing heretofore unknown advantages as described in the following summary.

### BRIEF SUMMARY OF THE INVENTION

The present invention is a method for efficient commuting and employs a commuting system having a network of roadways, a plurality of garaging hubs in traffic communication with the network of roadways, a plurality of mass transit vehicles, and a plurality of personal vehicles. Individual commuters are granted use of the commuting system as registered users. Each of the users is given access to one of the personal vehicles at a first selected one of the garaging hubs for use in moving between this hub and the user's home. Each of the users is likewise given access to another one of the personal vehicles at a selected second one of the garaging hubs for use in moving between this hub and the user's workplace. Between these two hubs, the user is given access to the mass transit vehicles. The personal vehicles are generally driven by users on a single trip basis. Once a vehicle is dropped off at a hub, it becomes available to be used by another user. The same user may pick up the same vehicle when leaving the hub, but it is more likely that the user will pick up an alternate vehicle. Therefore, all personal articles must be removed from a vehicle that is being dropped off at a hub. A typical daily cycle includes dropping off a vehicle that was used over night or over a weekend at a hub; riding provided mass transit to a second hub, picking up a second vehicle for driving to a workplace and dropping the second vehicle at the same second hub upon completion of the work day; again riding provided mass transit from the second hub to the first hub and then picking up a further vehicle for driving home. As before, the vehicle driven home may be used that evening, or over a weekend, but is dropped off at the same hub where it was pickup up in the morning of the next workday.

Estimates show that implementation of the method can reduce freeway loading by up to thirty percent, reduce commute time and cost by up to fifty percent and reduce fuel consumption by up to seventy five percent. Implementation requires no technical development and relatively little construction. The present method uses a transportation system that achieves optimal efficiency in the vehicular commuting process with lower cost and with minimal loss of convenience to the commuter.

The concept of the present method is to replace the solitary commuter driving a personal vehicle over long commute distances with mass transit carriers coupled with providing each commuter with a personal vehicle at both ends of the commute. This has the advantage of the convenience of a private vehicle for personal needs both at home and at work, while freeing the roadway systems of most cars. In this scenario, the commuting roadways, mostly freeways and toll-ways, become open for commercial trucks and buses and essentially closed to private traffic during essential commuting times. This significantly reduces the travel time of both private commuters as well as commercial vehicles saving fuel, reducing costs in equipment and labor for hauling, and eliminating a great deal of atmospheric pollution including carbon dioxide.

A primary objective inherent in the above described apparatus and method of use is to provide advantages not taught by the prior art.

A further objective is to reduce commuting costs;

A further objective is to reduce commuting time;

A further objective is to increase leisure time;

A further objective is to reduce personal stress;

A further objective is to provide fuel savings;

A further objective is to reduce noise and gaseous pollutions;

A further objective is to reduce carbon dioxide emissions; and

A further objective is to reduce wear and tear on highways.

Other features and advantages of the present invention will become apparent from the following more detailed description, taken in conjunction with the accompanying drawings, which illustrate, by way of example, the principles of the presently described apparatus and method of its use.

### BRIEF DESCRIPTION OF THE SEVERAL VIEWS OF THE DRAWING(S)

Illustrated in the accompanying drawing(s) is at least one of the best mode embodiments of the present invention In such drawing(s):

FIG. 1 is a schematic diagram of the system of the present invention wherein rectangles are used to represent rapid transit units and small circles for cars; and

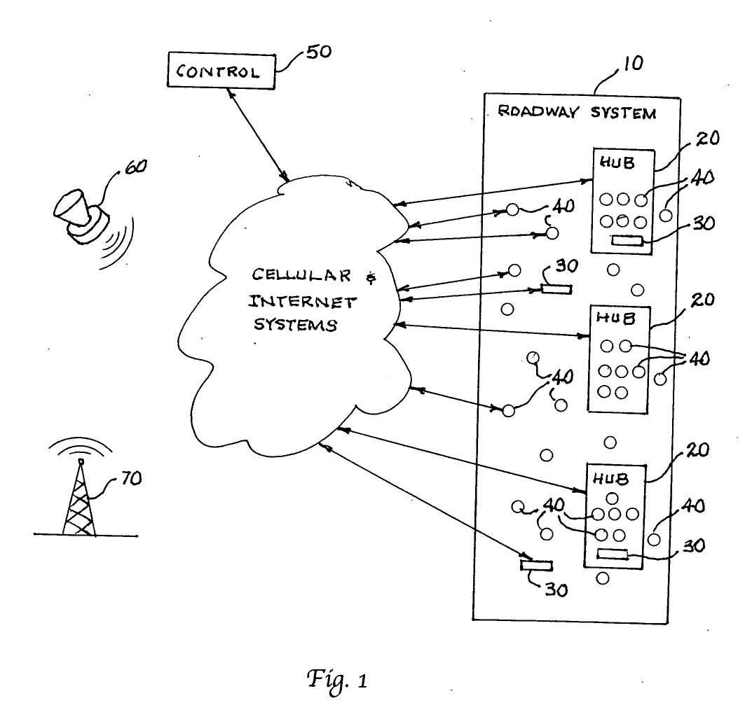

FIG. 2 is a flow diagram illustrating steps of the method thereof.

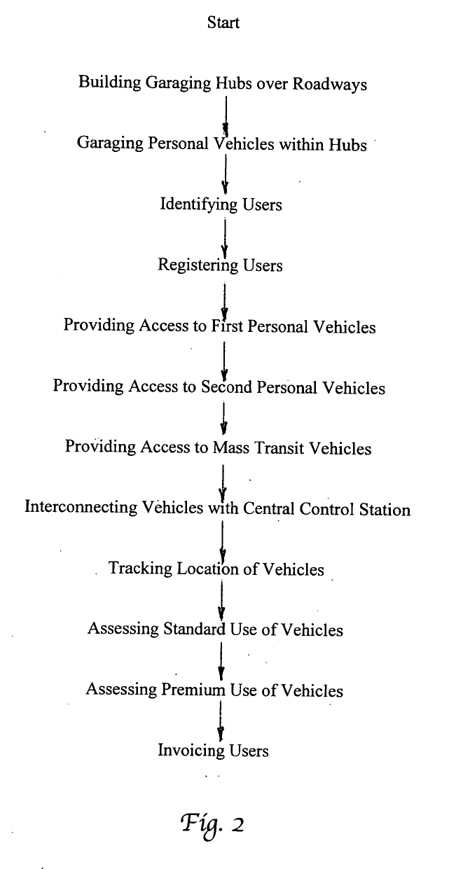

### DETAILED DESCRIPTION OF THE INVENTION

The above described drawing figures illustrate the described apparatus and its method of use in at least one of its preferred, best mode embodiment, which is further defined in detail in the following description. Those having ordinary skill in the art may be able to make alterations and modifications to what is described herein without departing from its spirit and scope. Therefore, it must be understood that what is illustrated is set forth only for the purposes of example and that it should not be taken as a limitation in the scope of the present apparatus and method of use.

Described now in detail is a method for efficient commuting. The method employs a commuting system having a network of roadways 10, a plurality of garaging hubs 20 which are in traffic communication with the network of roadways 10, a plurality of mass transit vehicles 30, and a plurality of personal vehicles 40. The method includes the steps defined below which are not listed in a preferred order.

Commuters are registered for use of the commuting system as registered users, and are then provided access to a first one of a plurality of personal vehicles 40 which are located at a first one of the garaging hubs 20′, typically the hub 20′ nearest to the user's home, for use in moving between the first selected one of the garaging hubs 20′ and the user's home. The user, upon arriving each day from work at the hub 20′ selects any one 40′ of the personal vehicles 40 which are garaged within the hub 20′. The user then has use of this vehicle 40′ to drive to his home, run errands, make stops at selected locations and do whatever the user would use his own private car for. It is the intent of the present method to replace the user's own car with vehicle 40′ for this utility. There are limitations on what the vehicle 40′ may be used for, and where it may be driven, and that will be discussed presently.

Registered users also are provided access to a second one of the plurality of personal vehicles 40 which are located at a second one of the garaging hubs 20″, typically the hub 20″ nearest to the user's workplace, for use in moving between the second selected one of the garaging hubs 20″ and the user's workplace. The user, upon arriving each day from home at the hub 20″ selects any one 40″ of the personal vehicles 40 which are garaged within the hub 20″. The user then has use of this vehicle 40″ to drive to his workplace, run errands, make stops at selected locations relative to his work or otherwise, and do whatever the user would use his own private car for when at, going to, and coming from work. It is the intent of the present method to replace the user's own car with vehicle 40″ for this utility. There are limitations on what the vehicle 40″ may be used for, and where it may be driven, and again, this will be discussed presently.

Finally, the registered user also is provided access, to the mass transit vehicles 30 for use in moving on the network of roadways 10 between the first selected one of the garaging hubs 20′ and the second selected one of the garaging hubs 20″ for going to the workplace and for going home. When traveling within one of the mass transit vehicles 30 either to work or to home, the user is able to relax and either work, enjoy reading the newspaper, sleep or do whatever other activity desired.

The garaging hubs 20 are preferably located at selected-positions on the network of roadways 10, preferably at the intersections of major routes, at major work centers and at major residential centers. Preferably, the garaging hubs 20 are constructed immediately above the roadways of the network of roadways 10 and may, in fact, advantageously straddle the roadways so as to require no land use other then the existing right of way of the roadway. Such a location enables the hub 20 to position traffic conduits, i.e., vehicular ramps and such, for instant access to the roadways 10 with access limited to system vehicles 30 and 40. In this way, also, little time is lost in moving between the personal vehicles 30 and the mass transit vehicles 30, which may be limousines, buses, trains and possibly aircraft, such as helicopters.

To enable the system to work requires identifying each registered user by an automated identification means which may include using a biometric variable such as finger print, iris scan, voice recognition, etc. Such identifying step preferably uses a scanned variable such as any of the well known scanning devices such as RFID scanning of a badge or card by the user. System enablement also requires interconnecting the personal vehicles 40 with a central control station 50 by a first wireless communication method, preferably using the cellular telephone communication system in conjunction with the Internet. This enables the control station 50 to be able to receive information about which user is using which of the personal vehicles. Other information that is readily available from moment to moment to the control station 50 is the technical status of each of the personal vehicles such as engine temperature, oil pressure, tire pressure, fuel level, odometer reading, etc., and use variables such as speed and distance traveled. If users are to pay for use of the personal vehicles, then this information is required to preparing billing to the users.

Tracking the physical location of each of the personal vehicles is accomplished using a second wireless communication method such as through the use of global positionind satellites (GPS) 60 or microwave, radio frequency or other land communication system 70 which enables the personal vehicles 40 to identify their location constantly. This information is then able to be made available to the control station 50 using the first wireless communication method described above.

Preferably, the users are charged a standard rate for miles driven in planned and initially requested use patterns, referred to herein as “primary” use of the commuting system, and particularly, the personal vehicles 40. As mentioned, such use is limited to driving between home and workplace and the selected hubs 20′ and 20″, as well as minor excursions for running errands, shopping, and so on, within specified range limits such as, for example, within 15 miles of workplace or home.

Preferably, users are charged a premium rate for miles driven in an ad-hoc manner, as for instance taking an unplanned trip to a distant work related location, or using the personal vehicle for commuting due to late or very early travel needs.

The enablements described in detail above are considered novel over the prior art of record and are considered critical to the operation of at least one aspect of the apparatus and its method of use and to the achievement of the above described objectives. The words used in this specification to describe the instant embodiments are to be understood not only in the sense of their commonly defined meanings, but to include by special definition in this specification: structure, material or acts beyond the scope of the commonly defined meanings. Thus if an element can be understood in the context of this specification as including more than one meaning, then its use must be understood as being generic to all possible meanings supported by the specification and by the word or words describing the element.

The definitions of the words or drawing elements described herein are meant to include not only the combination of elements which are literally set forth, but all equivalent structure, material or acts for performing substantially the same function in substantially the same way to obtain substantially the same result. In this sense it is therefore contemplated that an equivalent substitution of two or more elements may be made for any one of the elements described and its various embodiments or that a single element may be substituted for two or more elements in a claim.

Changes from the claimed subject matter as viewed by a person with ordinary skill in the art, now known or later devised, are expressly contemplated as being equivalents within the scope intended and its various embodiments. Therefore, obvious substitutions now or later known to one with ordinary skill in the art are defined to be within the scope of the defined elements. This disclosure is thus meant to be understood to include what is specifically illustrated and described above, what is conceptually equivalent, what can be obviously substituted, and also what incorporates the essential ideas.

The scope of this description is to be interpreted only in conjunction with the appended claims and it is made clear, here, that inventor believes that the claimed subject matter is what is intended to be patented.

What is claimed is:

1. A method for efficient commuting by employing a commuting system having a network of roadways, a plurality of garaging hubs in traffic communication with the network of roadways, a plurality of mass transit vehicles, and a plurality of personal vehicles; the method comprising the steps of:
a) registering commuters for use of the commuting system as registered users;
b) providing access, to each one of the registered users, to a first one of the personal vehicles at a first selected one of the garaging hubs for use in moving between the first selected one of the garaging hubs and the user's home;
c) providing access, to each one of the registered users, to a second one of the personal vehicles at a second selected one of the garaging hubs for use in moving between the second selected one of the garaging hubs and the user's workplace; and
d) providing access, to each one of the registered users, to the mass transit vehicles for use in moving on the network of roadways between the first selected one of the garaging hubs and the second selected one of the garaging hubs.

2. The method of claim 1 further comprising the step of locating each one of the plurality of garaging hubs at a selected position on the network of roadways.

3. The method of claim 2 further comprising the step, of building each one of the plurality of garaging hubs above the network of roadways at the selected position.

4. The method of claim 3 further comprising the step of positioning traffic conduits for private movement between the hubs and the network of roadways.

5. The method of claim 1 further comprising the step of providing at least one of: limousines, buses, trains and aircraft as the mass transit vehicles.

6. The method of claim 1 further comprising the step of identifying a registered user by an automated identification means.

7. The method of claim 6 wherein the identification means uses a biometric variable.

8. The method of claim 6 wherein the identification means uses a scanned variable.

9. The method of claim 1 further comprising the step of interconnecting the personal vehicles with a central control station by a first wireless communication method.

10. The method of claim 9 further comprising the step of tracking the location of each of the personal vehicles by a second wireless communication method.

11. The method of claim 9 further comprising the step of assessing each of the registered users a standard use tariff for approved use of the commuting system.

12. The method of claim 9 further comprising the step of assessing each of the registered users a premium use tariff for ad-hoc use of the personal vehicles.

13. A method for efficient commuting by employing a commuting system having a network of roadways, a plurality of garaging hubs in traffic communication with the network of roadways, a plurality of mass transit vehicles, and a plurality of personal vehicles; the method comprising the steps of:
a) registering commuters for use of the commuting system as registered users;
b) providing each said user access to a plurality of personal vehicles for local travel;
c) providing each said user access to mass transit vehicles for long distance travel.
d) driving between home and a first garaging hub in one of the personal vehicles;
e) traveling between the first garaging hub and a second garaging hub in a mass transit vehicle;
f) driving between the second garaging hub and a workplace in one of the personal vehicles and returning to the second garaging hub in the one of the personal vehicles;
g) traveling between the second garaging hub and the first garaging hub in a mass transit vehicle;
h) driving between the first garaging hub and home in one of the personal vehicles;
i) repeating steps (d) through (h) as required for meeting a user's business commuting needs; and
j) invoicing each user for use of the commuting system.

14. The method of claim 13 further comprising the step of locating each one of the plurality of garaging hubs at a selected position on the network of roadways and building each one of the plurality of garaging hubs above the network of roadways at the selected position.

15. The method of claim 14 further comprising the step of positioning traffic conduits for private movement between the hubs and the network of roadways.

16. The method of claim 13 further comprising the step of providing at least one of: limousines, buses, trains and aircraft as the mass transit vehicles.

17. The method of claim 13 further comprising the step of identifying a registered user by an automated identification means comprising at least one of a biometric variable and a scanned variable.

18. The method of claim 13 further comprising the step of interconnecting the personal vehicles with a central control station by a first wireless communication method and tracking the location of the personal vehicles by a second wireless communication method.

19. The method of claim 18 further comprising the step of assessing each of the registered users a standard use tariff for pre-approved use of the commuting system and assessing each of the registered users a premium use tariff for ad-hoc use of the personal vehicles.
